(19) United States
(12) Patent Application Publication
(10) Pub. No.: US 2026/0005392 A1
(43) Pub. Date: Jan. 1, 2026

(54) Mobile or Permanent Battery Energy Storage System

(71) Applicant: Dominion Energy, Inc., Richmond, VA (US)

(72) Inventors: Jonathan H. Warren, Toana, VA (US); Joshua G. Bell, Richmond, VA (US); Christina M. Hanlon, Disputana, VA (US); Jake R. Littlepage, Glen Allen, VA (US)

(73) Assignee: Dominion Energy, Inc., Richmond, VA (US)

(21) Appl. No.: 19/303,814

(22) Filed: Aug. 19, 2025

Related U.S. Application Data
(63) Continuation-in-part of application No. 18/601,040, filed on Mar. 11, 2024.
(60) Provisional application No. 63/448,791, filed on Feb. 28, 2023.

(51) Int. Cl. H01M 50/383; H01M 10/46; H01M 10/48; H01M 10/613; H01M 10/627; H01M 10/6561; H01M 50/204; H01M 50/24; H01M 50/251; H02J 7/35

(52) U.S. Cl. CPC H01M 50/383; H01M 10/46; H01M 10/482; H01M 10/613; H01M 10/627; H01M 10/6561; H01M 50/204; H01M 50/24; H01M 50/251; H02J 7/35; H01M 2220/10

(57) ABSTRACT

Mobile or permanent battery energy storage systems provide electrical power to locations with or without connections to the electrical grid or provide a more consistent supply of electricity. A battery energy storage systems meet the requirements of UL 9540, UL 9540A, and other regulations and codes for use due to the structure and control systems incorporated into the battery energy storage system.

### FIELD OF THE INVENTION

Mobile or permanent battery energy storage systems that provide electrical power to locations with or without connections to the electrical grid or provide a more consistent supply of electricity. Embodiments of the battery energy storage systems meet the requirements of UL 9540, UL 9540A, and other regulations and codes for use. Embodiments may comprise passive and/or active explosion mitigation systems.

### BACKGROUND

Batteries, such as but not limited to lithium-ion batteries, are the power source for nearly every portable electrical device including, but not limited to, automobiles, scooters, bicycles, laptops, portable power equipment, home backup power supplies, temporary power service in remote locations, and smartphones. Batteries are also used in mobile and permanent installations to provide storage for renewable energy sources to provide consistent power output.

The push for significantly more renewable electric power to combat climate change is exponentially increasing the demand for battery energy storage systems (BESS). Mobile BESS (MBESS) may be used for wedding venues, concerts, food trucks, and festivals that may require electricity for sound amplification, cooking, lights, heat, or other uses in places remote from the electrical grid or may need a greater supply of electrical power than is available at the venue. This electrical supply is conventionally supplied by fossil fuel generators for power production to run the equipment. However, these generators are inefficient, noisy, and exhaust noxious fumes and carbon dioxide. Fossil fuel generators also require constant refueling with a maintenance person supplying the generator with cans of gasoline which may result in spills.

As a result, the maintenance and operation of portable fossil fuel generators is expensive, inconvenient, and environmentally damaging due to fuel spills, organic vapors, exhaust, and routine tuning of the engine and breakdown repairs.

Emergency response personnel and organizations also require portable electrical power during emergency situations such as power outages and remote rescue operations. Again, currently the primary option to supply this electrical power is fossil fuel generators. The noise pollution and emissions make this a non-ideal solution, especially for short term housing solutions (tent cities) where people are trying to sleep or to be deployed for household use where both the noise and emissions would be intrusive to these residential areas. This is a growing concern as the need for restoration services and other emergency responses has increased in recent years.

There is a need for mobile or permanent BESS and other systems that provide electrical supply under normal conditions, in remote locations away from the electrical grid, under higher than normal demand, demand spikes, and temporary demand requirements. There is also a need for a mobile or permanent BESS that has effective explosion mitigation systems.

### SUMMARY

Mobile and permanent BESS systems over a certain size must meet specific fire and safety regulations to be used for power supplies. An embodiment of a MBESS, for example, comprises a trailer, a trailer base on the trailer, battery rack system connected to the trailer base, a plurality of batteries, battery cells, and/or battery modules (hereinafter, “battery modules”) supported on the battery rack system, and an enclosure. The BESS has specific design and structure features that allow the BESS to be UL 9540 compliant. The battery rack system comprises a plurality of battery module bays that house and secure the battery modules that are specifically secured, arranged, and configured to meet such regulations. The batteries may be manufactured from new materials or recycled materials.

In one embodiment, a BESS, comprising a trailer comprising an enclosure and a trailer base comprising wheels and a trailer base. The BESS comprises a plurality of battery modules in electrical communication. Due to the potential risks of overheating, fire, or generation of flammable gases during use or charging of the batteries, battery cells, and/or battery modules, a fire suppressant system may be included within the enclosure. The fire detection and suppressant system are configured to perform at least one of the following responses to sensors indicating a potential hazard within the enclosure, sounding a visual and/or audible alarm, starting the ventilation system to reduce the flammable gas concentrations in enclosure, and igniting combustible off gas upon indication of dangerous buildup of hazardous off gas.

Embodiments of the permanent, temporary, or mobile BESS (hereinafter “BESS”) may comprise an explosion mitigation system. The explosion mitigation system may include at least one of an active and passive ventilation systems that release over pressurization within the enclosure, explosive, or combustion gases safely, for example. An explosion mitigation system may include one or more engineered safety features designed to reduce the effects of a fire, explosion, other episode, such as an increase in pressure, generation of excess heat, fire, and/or flying debris in order to protect people, equipment, and infrastructure in the vicinity of the BESS. The passive explosion mitigation systems may include, but are not limited to, deflagration vents, explosion vent panels, automatic door openers, pressure-relief doors, blast panels, explosion relief panels, flame arrestors, and/or pressure release dampers, for example. The active explosion mitigation may use power driven components and include, but are not limited to, exhaust ventilation systems, ignition-free sparkless ventilation systems, inert gas suppression systems, spark ignition systems for controlled combustion, and/or gas detection with automatic shut down and venting, for example.

The BESS may comprise at least one of a local and remote emergency information systems. The local and/or remote emergency information systems provide a monitoring capability for the fire monitoring systems, a fire suppressant system, and/or the fire mitigation systems. For example, a remote fire panel may be in wireless communication with the fire monitoring system and the fire mitigation system and provides a graphical monitoring interface for first responders and facility managers.

A battery rack is supported on the trailer base or a permanent or temporary immobile support structure to secure at least one of the battery modules, bus bars, sensors for monitoring battery status and safety issues, a battery management control system, and electric inverters, for example. In one embodiment, the battery rack comprising a first shelf for receiving a first battery module and a second shelf for receiving a second battery module.

A battery module may have a container comprising a plurality of battery cells within a container. Each battery module may comprise a management system. Each battery module may be UL 9540A compliant, UL 1973 compliant, or both.

In one embodiment, the first battery module comprises a first container and the second battery module comprises a second container. The first container and the second container define a first flow channel for the air flow and cooling between the first shelf and the second shelf and the first container and the second container. The flow channel allows the air to cool the battery modules and to prevent or reduce the chance that an issue with one battery module will affect another battery module.

### BRIEF DESCRIPTION OF THE FIGURES

FIG. 1 depicts an embodiment of a battery module rack for a BESS, the shown embodiment comprises six shelves for receiving six battery modules, support members for three DC to A/C inverters and/or a DC to DC transformer, bus bars, sensors, battery management systems, and other components of the BESS;

FIG. 2 depicts the battery module rack of FIG. 1 with the six battery modules on the shelves;

FIG. 3 depicts an enclosure for a BESS comprising doors for accessing the battery modules and inverters incorporated into the enclosure and a passive explosion mitigation vent;

FIG. 4 is a flowsheet that depicts the basic control and monitoring system of the BESS;

FIG. 5 depicts an embodiment of the solar panels installed on the roof of the enclosure of the BESS;

FIG. 6 depicts an embodiment of the rack comprising a top shelf to support the inverters in a horizontal orientation; and

FIGS. 7A through 7H depict an embodiment of the enclosure 100 of a BESS comprising a shell 101 and a frame 102; wherein FIG. 7A is a perspective view from the right rear of the enclosure showing two rear access doors 103A and 103B for accessing the rear of the battery rack and installing or removing battery modules or the battery rack and showing a right side deflagration vent 104R; FIG. 7B is a perspective view of the left rear of the enclosure depicting three battery module access doors 105L, 105C and 105R (for monitoring and maintaining the battery modules) and deflagration vent 104L; FIG. 7C is a top view of the enclosure of FIG. 7A showing the roof of the enclosure 107 and the mounting flanges 106L, 106R, and 106B for mounting the enclosure onto a trailer; FIG. 7D depicts a right side elevation view of the embodiment of the enclosure of FIG. 7A showing the layout of the three battery module access doors 105L, 105C and 105R and the deflagration vent 104L; FIG. 7E is a rear elevation view of the embodiment of the enclosure of FIG. 7A showing the rear access door that opens to provide access to the inner volume of the enclosure; FIG. 7F shows the left side elevation view of the embodiment of the enclosure of FIG. 7A showing the layout the deflagration vent 104L on the left side of the enclosure; FIG. 7G shows the front elevation view of the front of the enclosure of FIG. 7A; and FIG. 7H shows the rear right side perspective view of the internal frame of the enclosure.

### DESCRIPTION

The battery rack may comprise a first row of a plurality of shelves for receiving a first row of a battery modules and a second row of a plurality of shelves for receiving a second row of batteries modules. The battery rack may comprise a third shelf and a third battery module may be received on the third shelf. In such an embodiment, the second container and the third container of the third battery module define a second flow channel for the air flow and cooling between the second shelf and the third shelf and the second container and the third container. The battery rack may comprise additional shelves to meet the voltage or capacity requirements of the BESS.

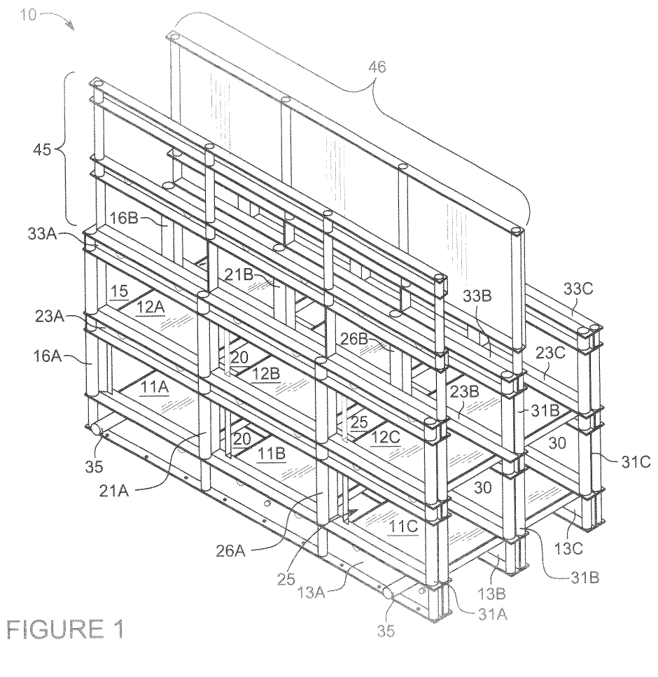

An embodiment of a battery rack 10 is shown in FIG. 1. The battery rack 10 of FIG. 1 comprises a first row comprising three battery shelves, a first battery shelf 11A, a second battery shelf 11B, and a third battery shelf 11C and a second row also comprising three battery shelves, a fourth battery shelf 12A, a fifth battery shelf 12B, and a sixth battery shelf 12C. The first vertical channel 20 is defined between the first column of battery shelves 11A 12A and a second column of battery shelves 11B 12B. A second vertical channel 25 is defined between the second column of battery shelves 11B 12B and a third column of battery shelves 11C 12C. The first vertical channel 20 and the second vertical channel 25 allow a space between the battery modules to prevent high temperatures excursions, fire, or explosion in one battery module from easily affecting an adjacent battery module. In the embodiment shown in FIG. 1, the vertical channels are formed as gaps between the adjacent shelves, however, these gaps may comprise a continuation of the shelves with apertures, vents, or grates, for example. The vertical channels allow air flow between the battery modules and may comprise additional features.

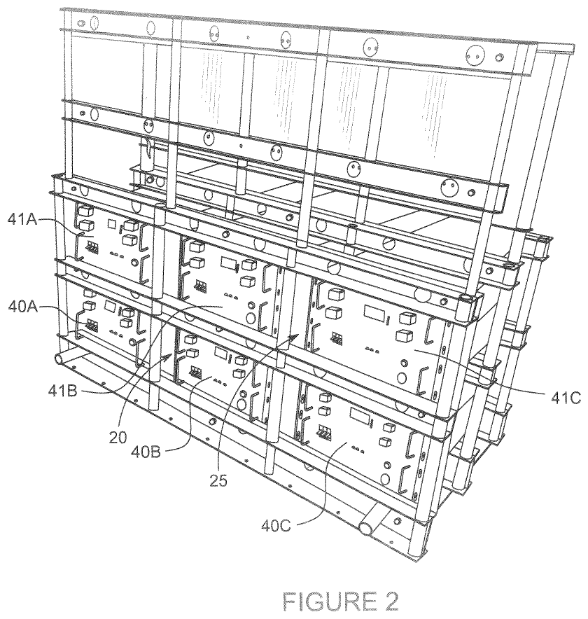

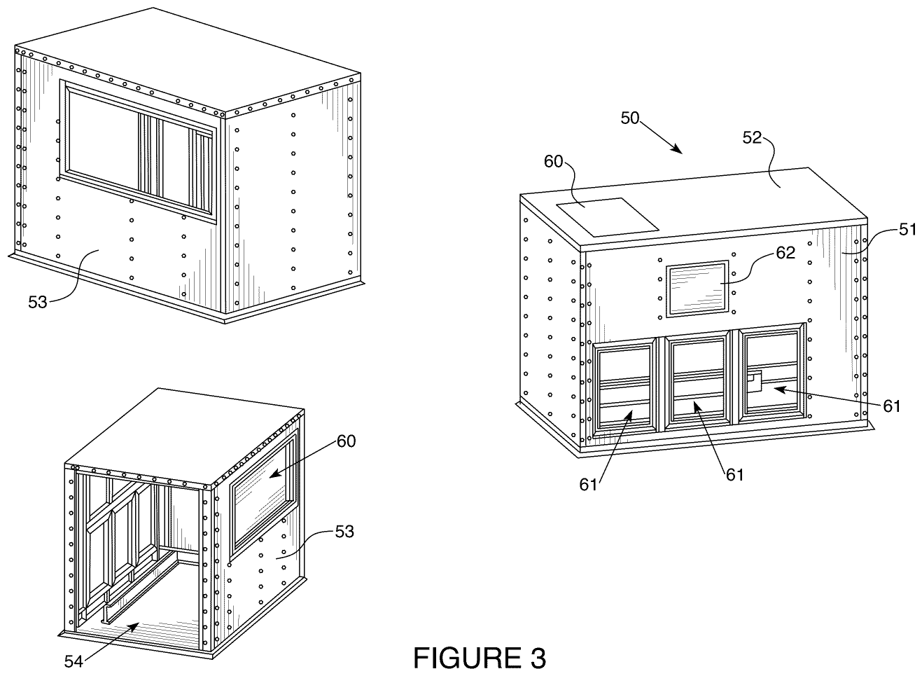

FIG. 2 depicts the six shelf battery rack of FIG. 1 with six battery modules installed on the shelves. The first row of shelves 11A 11B 11C receive battery modules 40A 40 B 40C and the second d row of shelves 12A 12B 12C receive battery modules 41A 41B 41C. The depicted battery modules are 48/51.2 Volts, 300 Amp-Hour, and are certified to UL 1973 and UL 9540a Standards. The battery modules each comprise 48 102 amp-hour battery cells and include a 200 amp battery management system within a battery module container. They are configured to be installed with forty-eight volt class inverters, battery chargers, and solar charge controllers. The shelves may comprise a gasket such as, but not limited to, a resilient rubber gasket. The gasket may lie flat on a shelf and has a lip around the sides to receive a battery module. Another gasket between the battery units may be a small strip that basically prevents movement or vibration of the battery modules. There is still an air gap between the battery module containers and the rack. The battery module containers further define vertical channels 20 25. The vertical channels are open to the right and left side of the battery rack to further enhance the air flow around the battery modules. Referring again to FIG. 1, the battery rack 10 comprises left side vertical support members 16A 21A 26A 31A, middle vertical supports 16B 21B 26B 31B, and rights side vertical supports 31C (16C 21C 26C not numbered). The vertical supports may be pipes or tubes that are slipped over a structural inner pipe. The shelves then rest upon the vertical supports and are structurally supported by the inner pipe connected to the base of the rack. The middle vertical support 21B is within the first vertical channel 20 and middle vertical support 26B is within the first vertical channel 25. The left side vertical support members and the right side vertical support members are outside of the battery module shelves to provide and define further air flow channels on the left side and right side of the battery rack. Horizontal support members, such as lower horizontal support members 13A 13B 13C, central horizontal support members 23A 23B 23C, and upper horizontal support members 33A 33B 33C rest upon the vertical supports and provide support for the battery module shelves. Each battery module may weigh more than three hundred pounds. This embodiment of the battery rack must support the weight of six batteries and the inverters. Alternatively, the embodiment of the BESS may comprise direct access to DC voltage or a transformer for providing a different DC voltage than the battery output.

The inverters convert DC electricity from the battery modules or the solar panels to AC electricity and may be supported on a second upper support rack 46. The inverters may be UL 1741 compliant. The inverters may be laid flat to reduce the height of the BESS system. The battery rack 10 may further comprise a bus bar to electrically connect the battery modules and inverters. A bus bar may be mounted in any convenient location on the shelves or installed inside the rack.

In embodiments of either the permanent or the BESS may comprise an enclosure for the battery rack, battery modules, and other components. The enclosure 50 may comprise a left side wall 51, a right side wall 53, and a roof 52. The battery module containers 40A-C 41A-C and the front wall 51 define a third flow channel for air flow and cooling. In another embodiment, the second container and the first side wall further define the third flow channel for air flow and cooling.

The battery rack may comprise four studs 35 on the sides of the battery rack system. The four studs 35 may be received into locking slots on the base of the trailer. The four studs may be locked with the locking slots by a cap, U-bolt, or any means known in the art.

Embodiments of the permanent or mobile BESS may comprise at least one explosion mitigation system. An explosion mitigation system may include one or more engineered safety features designed to reduce the effects of a fire, explosion, other episode, such as an increase in pressure, generation of excess heat, fire, and/or flying debris in order to protect people, equipment, and infrastructure in the vicinity of the BESS. The passive explosion mitigation systems may include, but are not limited to, deflagration vents, explosion vent panels, automatic door openers, pressure-relief doors, blast panels, explosion relief panels, flame arrestors, and/or pressure release dampers, for example. The active explosion mitigation may use power driven components and include, but are not limited to, exhaust ventilation systems including exhaust blowers or fans, ignition-free sparkless ventilation systems, inert gas suppression systems, spark ignition systems for controlled combustion, and/or gas detection with automatic shut down and venting, for example. Active and/or passive ventilation systems both release over-pressurization within the enclosure and/or explosive or combustion gases safely, for example.

Deflagration vents are pressure-relieving panels that rupture when exposed to a specific pressure differential. Typically, these deflagration vents are used to relieve an internal pressure build up inside an enclosure. In this specific embodiment, a thermal runaway event of the batteries may lead to gas accumulation within the BESS enclosure. The deflagration vents will rupture at a desired pressure thereby directing hot gases and/or flames away from the critical infrastructure of the BESS and avoid further damage. Blast panels may also be included in the BESS enclosure. The blast panels are light weight, structurally engineered panels that detach or break away with an explosion that occurs or pressure increases to a potentially damaging level within the BESS enclosure.

Automatic door openers or pressure relief doors or pressure relief dampers (automatic door openers) are passive explosion mitigation devices that may also be built into a BESS enclosure. The automatic door openers or pressure relief doors, similar to deflagration vents, are designed to open automatically when an alarm is received Automatic door open shall be used to expel the flammable off gas from inside of the enclosure to the exterior.

Flame arrestors may be incorporated into any vent on the enclosure of the BESS. Flame arrestors comprise fine mesh or sintered metal filters that cool and quench flames, preventing them from traveling through or out of piping or ventilation systems.

Active systems detect and respond to conditions that could lead to an explosion, using power-driven components to prevent or mitigate potential events.

The BESS enclosure may comprise a forced ventilation system, which may include at least one of intake and exhaust fans, designed to expel flammable gases from within the enclosure and, therefore, maintain safe gas concentrations within in the enclosure. Fans may be installed and connected to sensors that continuously or intermittently monitor gas concentrations within the enclosure. If a threshold is exceeded, the fan or fans are activated to reduce the concentrations of gasses.

Alternatively, or additionally, the BESS enclosure may comprise a specialized ventilation system designed to eliminate sparks or static discharges that could ignite combustible gases. The specialized ventilation system comprises non-sparking, explosion-proof fans, and components to safely remove hazardous gases.

Embodiments of the BESS enclosure may be equipped with an inert gas system. The inert gas system and/or the forced ventilation system may be triggered by temperature or gas concentration sensors. If triggered, the inert gas system will release an inert gas such as, but not limited to, nitrogen or argon, into the enclosure to reduce oxygen concentration and prevent fire or explosions. For example, if flammable gas concentrations reach dangerous levels, an inert gas is released to displace oxygen, preventing ignition.

Another embodiment of an active explosion mitigation system is a sparkler ignition system for controlled combustion. A controlled ignition system may ignite and burn small gas accumulations in a controlled manner before they reach explosive levels. Automated sparkler generators or pilot flames to ignite small amounts of gas at low concentrations, preventing dangerous buildup.

Certain active explosion mitigation systems my comprise gas detection with automatic shutdown of the BESS system and venting of any accumulated gases. In such systems sensors monitor gas levels and trigger automatic exhaust fans or shut down high-risk components when thresholds are reached.

The BESS may comprise at least one of a local and remote emergency information systems that is configured to monitor the conditions with the BESS enclosure. The local and/or remote emergency information systems provide a monitoring capability for the fire monitoring systems, a fire suppressant system, battery management system, and/or the fire mitigation systems. For example, a remote fire panel may be in wireless communication with the fire monitoring system and the fire mitigation system and provides a graphical monitoring interface for first responders and facility managers. The emergency information systems may support communication with multiple fire alarm local or remote panels.

Optionally, the emergency information systems may have a connection to a central monitoring station. The central monitoring station may then distribute the status information through communication systems to additional remote monitoring systems or panels. For example, the central monitoring station enables individual signal transmission or communication to offsite remote monitoring. The central monitoring station may be a cloud based system, local wired or wireless, or a LAN-connected system for a flexible deployment that meets the needs of BESS users.

In some embodiments, the communication between the emergency information systems and the remote systems or panels is two way communication. For example, the remote systems or panels may communicate with the emergency information systems to operate the active explosion mitigation systems. For example, a user may manually activate a mitigation system such as a ventilation system, door opening systems, thermal run away control systems, and the gas detection systems. These mitigation systems may also be automatically activated by the emergence information systems when signals from the environmental sensors indicate an off normal status that requires an automatic response.

The remote panel may be used to provide remote safety and/or emergency shutdown or lock out features to remotely prevent local activation of the BESS.

In one embodiment, the local and/or remote emergency information system provides at least one of graphical or textual monitoring interface of normal and/or off normal events. The system may comprise a monitoring software platform, a fire panel gateway providing access to the BESS safety components and systems, a mobile or local device such as, but not limited to a mobile phone, a tablet, and/or a personal computing device such as a desktop or laptop computer, and wireless and/or wired network connectivity infrastructure, for example.

An embodiment of the local and/or remote emergency information system provides real time monitoring of the safety systems. The real time monitoring provides access to real time information concerning the BESS safety systems. Real-time monitoring refers to monitoring of information that becomes available and accessible immediately or shortly after it is generated or collected. It is characterized by insignificant or no delay, allowing for in-the-moment decision-making and quick responses to changing or emergency conditions. Unlike historical data, which reflects past events, real-time data provides current information. Real-time information may not be stored in the generating device but is forwarded to users or applications as soon as it is collected, ensuring the most up-to-date information.

The BESS may comprise a passive explosion mitigation vent installed in the side walls 62 or passive explosion mitigation vent 60 installed in roof 50 of the enclosure 52. A passive explosion mitigation vent is a safety device that opens or ruptures at a predetermined pressure to safely relieve pressure from within the enclosure 50 due to an explosion, fire, or other source of over pressurization. The passive explosion mitigation vents may be mounted above the battery rack, bus bars, and inverters. In the event of catastrophic thermal runway, the vents provide a safe “weak point” in the trailer enclosure for an explosive force to dissipate though. The explosive force and pressure are thus harmlessly released upwards and directed away from the sides of the trailer where people may be, not outwards through the doors.

Examples of combinations of BESS safety and fire combinations include, but are not limited to, the following examples:

An embodiment for utility systems with the most advanced safety systems includes all the high-end safety features. This includes Notifier Onyx Series fire panel, IR smoke detectors, QTY2 Hydrogen gas detectors, explosion proof active ventilation system.

Another embodiment for short term use will meet the requirements for Mobile BESS International Fire code and local fire codes. It will include a fire panel and detectors.

If a thermal runaway commences, gas including flammable or explosive compounds may be released into BESS enclosure. The gas concentration sensors can indicate a thermal runaway by monitoring the internal environment for concentrations of such gases within the enclosure. The fire detection and suppressant system may be programmed to respond to indications of the presence of flammable or explosive gases such as, but not limited to, hydrogen, methane, carbon monoxide, or other gases. The gas detector or smoke alarm may measure increasing LFL levels in enclosure, trigger alarm, and activate the mitigation systems. Additionally, manual activation of the explosion mitigation system is also possible at secondary fire panel or a remote fire panel.

The fire detection and suppressant system may activate an automatic door opener system (passive mitigation) on one or more sides or the roof of the BESS enclosure. If the gas concentrations with the BESS enclosure do not reduce to below safe levels or accumulation increases, the fire detection and suppressant system may activate the active mitigation system. For example, the fire detection and suppressant system may activate one or more intake or exhaust fans drawing fresh air into enclosure to reduce LFL readings to below dangerous levels.

The activation point of the active mitigation system would be at a gas concentration that indicates the presence of flammable or explosive gas concentrations. The passive mitigation system and/or the active mitigation system may be activated at a gas concentration above zero concentration and below a dangerous level. The passive mitigation system and/or the active mitigation system may be initiated at the first indication of explosive or flammable gases such as at a trigger concentration between 1% and 25% of the LFL of a gas including, but not limited to, any one of 1%, 5%, 10%, 15%, 20%, or 25% of the LFL of the sensed compound, for example. In some embodiments, the passive mitigation system is initiated first, and if the LFL continues to increase, the active mitigation system may be activated at a higher gas concentration than the passive mitigation system. For example, the active mitigation system may be initiated at sensed concentration from 1% to 10% higher LFL than the passive mitigation system, for example, the active mitigation system may be initiated at an LFL of 10%, 20% or 25% of the LFL of the sensed compound. The goal of the passive and active mitigation systems is to prevent the buildup explosive or flammable gases to their LFL. Activation of both systems should maintain the LFL of any compound below 25% in most runaway situations.

In one embodiment, a BESS comprises an enclosure defining an inner volume, doors that seal the enclosure and allow access to any inner volume. Since the inner volume may experience accumulation of dangerous gases from a battery overheating, for example, the BESS may also comprise a fire detection and monitoring system comprising sensors to monitor the inner volume for concentrations of combustible or flammable gases. In a preferred embodiment, the fire detection and monitoring system comprises a passive mitigation system that responses to a build-up of pressure and/or combustible or flammable gases in the inner volume and an active mitigation system comprising at least one of an exhaust blower or intake fan that is operated by the fire detection and monitoring system when concentrations of combustible gases reach above a certain level of the lower flammable limit. The passive and active mitigation systems have sufficient flow capacity to maintain the concentration of combustible gases below 25% of the lower flammable limit of the combustible gas as calculated by computational fluid dynamics analysis.

### Example 1

In a more comprehensive embodiment, the BESS comprises safety features that monitor, report, and mitigate any potential fire or explosion event. The BESS includes a fire detection system that meets safety standards and manages fire alarms and other alerts, monitors the safety sensors, and controls the mitigation devices. This embodiment comprises an intelligent fire control panel such as a Honeywell Onyx Series control panel. Such control panels comprise a Boolean logic to control reporting and mitigation systems. The fire control panel manages fire alarms and alerts.

Smoke detectors will be placed inside the battery storage area and may be in electrical communication with the fire control panel and are spaced according to airflow to provide a more complete monitoring of the enclosure.

The BESS will also include a remote fire panel for first responders to monitor the area. The remote fire panel is in wireless communication with the fire control panel so that the status of the BESS may be monitored in real time from the remote fire panel.

The safety system also comprises a plurality gas detection system that monitors for hydrogen gas within the enclosure and is in communication with the fire detection system and the remote fire panel to provide readings to emergency responders.

The fire detection system may also comprise an exhaust ventilation system that will help release flammable gases from the container. The exhaust ventilation system may be passive or active explosion mitigation system.

The BESS fire detection system has a backup power source that is independent of the battery system to operate the fire detection system even if the BESS is inoperable or shut down for safety concerns.

The fire detection system and mitigation devices will automatically activate during gas leaks or other emergencies. Safety vents, passive or active, will help manage pressure inside the container. For example, an automatic door opener will help release gases safely from the container when the sensors indicate high concentrations of explosive or flammable gases. The system will trigger automatically in emergencies and has manual controls for first responders.

The BESS enclosure also comprises sample ports for testing air quality inside the enclosure before entry or opening. A fire department connection will be installed outside the enclosure for easy access during emergencies.

### Example 2

In an embodiment of a BESS comprising sufficient safety features that meet the applicable safety standards and regulations. Such a BESS comprises safety features that monitor, report, and mitigate any potential fire or explosion event. The BESS includes a fire detection system that manages fire alarms and other alerts, monitors the safety sensors, and controls the mitigation devices. Similarly, this embodiment comprises an intelligent fire control panel such as a Honeywell Onyx Series control panel. Such control panels comprise a Boolean logic to control reporting and mitigation systems. The fire control panel manages fire alarms and alerts.

UV/IR detection systems will be set up to monitor potential hazards and may be pointed downward for more effectiveness. A sparker system will ignite any gas buildup inside the container automatically, working independently of the battery system and operating on battery backup if necessary.

Pressure-sensitive or deflagration vents can be installed on the roof or side wall of the enclosure to release built-up gases safely. These vents will be designed based on local weather conditions and will be tested to ensure they work properly.

Smoke detectors will be placed inside the battery storage area and may be in electrical communication with the fire control panel and are spaced according to airflow to provide a more complete monitoring of the enclosure.

The BESS will also include a remote fire panel for first responders to monitor the area. The remote fire panel is in wireless communication with the fire control panel so that the status of the BESS may be monitored in real time from the remote fire panel.

The safety system also comprises a plurality gas detection system that monitors for hydrogen gas within the enclosure and is in communication with the fire detection system and the remote fire panel to provide readings to emergency responders.

The fire detection system may also comprise an exhaust ventilation system that will help release flammable gases from the container. The exhaust ventilation system may be passive or active explosion mitigation system.

The BESS fire detection system has a backup power source that is independent of the battery system to operate the fire detection system even if the BESS is inoperable or shut down for safety concerns.

The fire detection system and mitigation devices will automatically activate during gas leaks or other emergencies. Safety vents, passive or active, will help manage pressure inside the container. For example, an automatic door opener will help release gases safely from the container when the sensors indicate high concentrations of explosive or flammable gases. The system will trigger automatically in emergencies and has manual controls for first responders.

The BESS enclosure may also comprise sample ports for testing air quality inside the enclosure before entry or opening. A fire department connection will be installed outside the enclosure for easy access during emergencies.

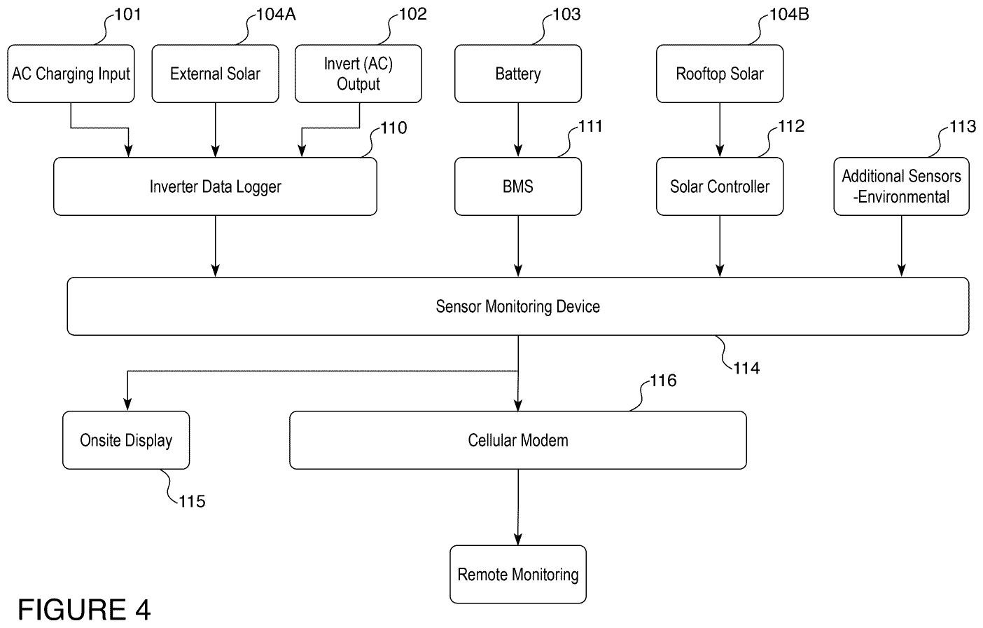

Embodiments of the BESS comprise an electrical control system, A/C and solar power charging systems, status, and monitoring system (hereinafter, “monitoring system”). An embodiment of a status and monitoring system is shown in FIG. 4. The monitoring system 100 shown in FIG. 4 comprises an inverter data logger that receives input from the A/C charging input 101 and the A/C inverter output 102. The BESS may be charged by plugging into an A/C power source such as the electrical grid, for example. The BESS may be configured to output either A/C or DC power.

The individual battery modules may comprise an internal battery management system and the BESS may comprise its own mattery management system 111 that monitors and balances the charges between the plurality of battery modules 103.

The system may further comprise additional sensors 113. Additional sensors 113 include, but may not be limited to, temperature sensors, voltage sensors, and amperage sensors, for example, to determine the state of the battery modules. For example, the battery management system 111 may continuously monitor the temperature of each of the battery modules 103 to ensure that the plurality of individual battery modules 103 are operated safely during both charging and discharging.

If one battery module overheats, the battery management system may isolate the overheating battery module and at least a portion of the load or charging may be switched from the overheating battery module to the normally functioning battery module. In other embodiments, each of the battery modules may be configured into multiple individual packs and the battery management system may be configured to monitor each of these multiple packs.

The battery management system 111 may also control normal operation of the portable battery device. For example, during initial load or during peak loading, the battery management system 111 controls a balance between all the battery modules to provide the required amperage. During uncontrolled charging, lithium ion batteries may experience thermal spikes and, if overcharge occurs, there is a potential for a fire or explosion. The battery management system 111 may therefore monitor each of the battery modules during charging and adjust the charging voltage or amperage to each battery module to prevent overheating and damage to the cells. The battery management system may then balance the load appropriately.

In some embodiments, the battery management system may comprise at least one sensor monitoring device microcontroller unit (MCU) 114. Embodiments of the MCU or MCUs 114 may perform at least one of functions of monitoring the battery modules or individual cells of the battery modules, protecting the battery modules by controlling loads, estimate each of the battery modules state and remaining life, maximize each of the battery modules performance, data logging, controlling the load on each battery module, isolating a battery module that is showing signs of overloading or overheating, as well as other desired functions, for example. The MCU may comprise a local display reporting the status of the BESS components and all the individual battery modules. The MCU may comprise a modem or other communication device 116 to communicate the status of the BESS components and all the individual battery modules. The monitoring system may display or report, either locally or remotely, BESS status information. The BESS status information may include battery diagnostic information, solar system diagnostic information, power output/input information, fire safety information, and environmental information inside and outside the enclosure.

The BESS status information may be triggering a fire alarm strobe or siren, software monitoring and reporting, triggering mechanisms to electrically disconnect all batteries from the unit.

For individual cell safety in each battery module, the MCU or MCU 114 may prevent any individual cell or group of cells from an overvoltage situation inside the battery module. In such as case, the MCU may isolate an individual battery module or a group of battery modules, as necessary, to prevent the temperature of any battery module or group of battery modules, from exceeding the upper threshold limit by reducing/stopping the current or activating a cooling system in the battery module to prevent thermal runaway; prevent any cell, group of cells, or battery module from going into an under-voltage situation by limiting/stopping the discharge current; protect the individual battery modules from short circuit and overload situations by isolating the battery module from the voltage supply circuit. The vertical channels also prevent battery module overheating by allowing air flow around the battery modules.

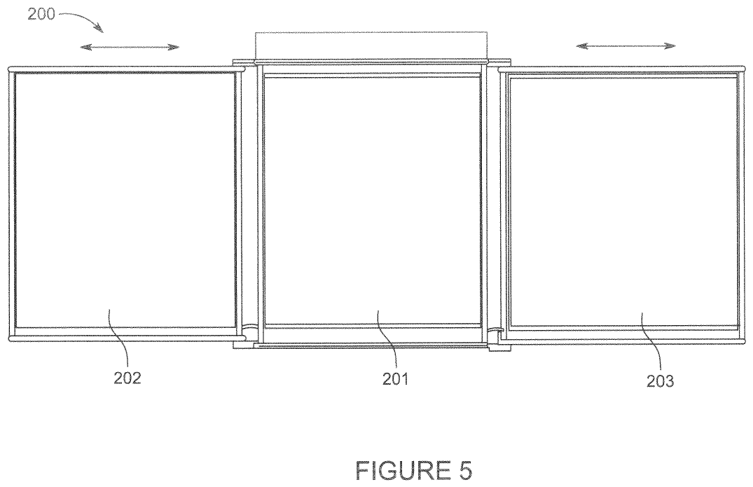

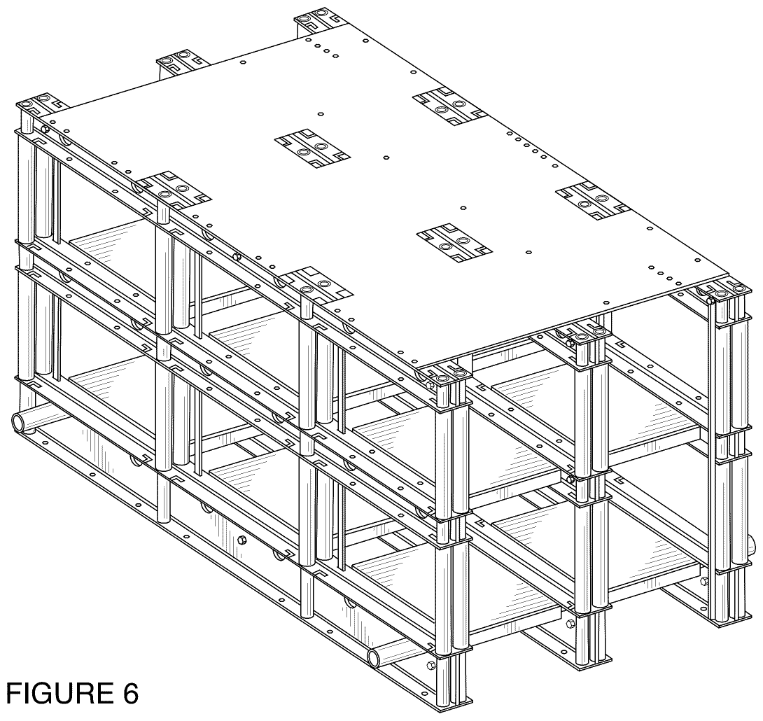

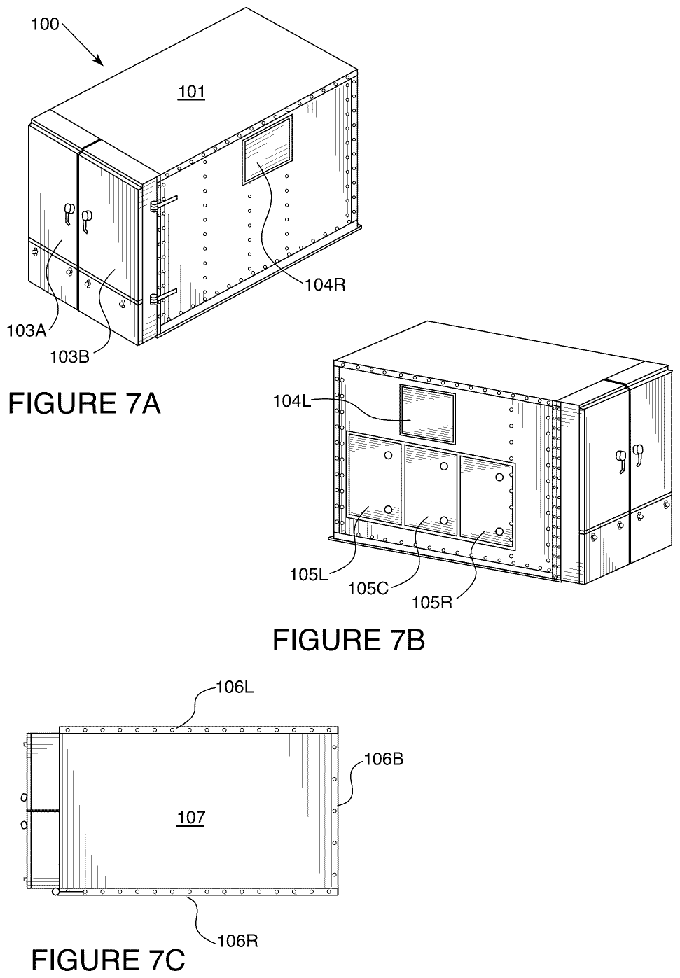

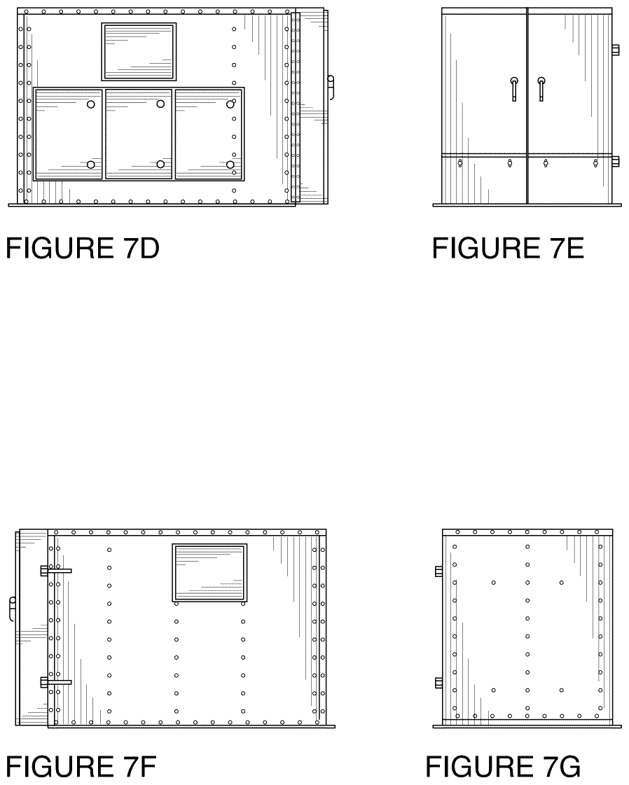

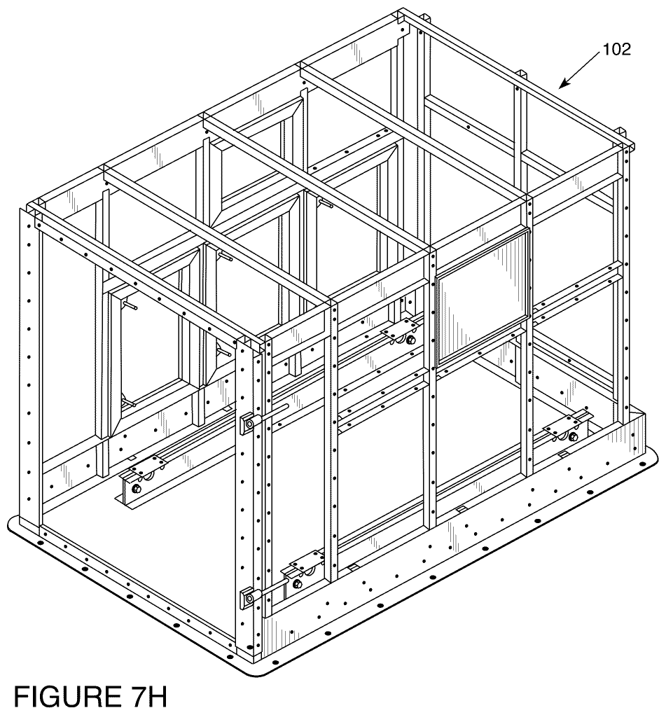

The monitoring system 114 may further monitor and report the status of the solar panels 104 which are connected to a solar power controller 112. In an embodiment, the BESS comprises photovoltaic solar panels that produce electrical energy to charge the batteries or directly provide power to the inverters. In one embodiment, for example, the BESS comprises three photovoltaic solar panels to charge the batteries or supply electrical power. The photovoltaic solar panels may be mounted slidably on top of the enclosure to allow storing the solar panels while the portable BESS or MBESS is being towed on the highway and sliding the solar panels to a deployed position for charging while the BESS or MBESS is being used. In the embodiment shown in FIG. 5, the solar array 200 is mounted on top of the enclosure 50 with one solar panel 52 fixedly connected to the roof of the enclosure and two solar panels 202 203 slidably mounted on the roof 52.

In a preferred embodiment, the BESS comprises a fire safety and detection system and prevention system configured to activate the fire protection system. The fire detection system comprises optical sensors for monitoring the environmental conditions within the enclosure. Optical detectors may include infrared (“IR”) and ultraviolet infrared (“UV-IR”) detectors. The UV-IR detector monitors the environment for combustible gas or vapor protection systems. If the UV-IR detector measures a sufficient concentration of combustible gas within the enclosure the explosion prevention system activates a sparkler system configured to ignite a localized concentration of gases within the enclosure. In one embodiment the trailer fire safety system is configured to provide a safe operation of the trailer. The fire detection system may comprise a fire panel housing the UV and IR detection sensors and an active explosion prevention system comprising the sparkler system to ignite localized concentration of gases in the container.

The UV detection sensor and IR detection sensor are both mounted inside the trailer and wired to the fire panel. The fire protection system also comprises an active explosion prevention system. This system may also be connected to the fire panel. In the event of battery failure and a leaking of flammable off-gas, upon detection the sparkler system will ignite the gas before catastrophic build up. These systems in conjunction with each other provide a safe product in the event of catastrophic failure.

Embodiments of the BESS are configured to safely stack six battery modules in an enclosed environment mounted on a UL-1973 approved rack system. The structure of the battery rack, enclosure, and safety systems ensure that if one battery module experiences thermal runway, it does not propagate to the batteries mounted nearby.

### EXEMPLARY EMBODIMENT

A BESS comprises main components as follows:
A rack system wherein the battery modules are received in individual separate bays that house the batteries and secure them in place.
A main enclosure wherein the main enclosure is connected to the supporting structure. The support structure may be a support frame, skid, or cargo container, for example. The enclosure may comprise openings to access the batteries on one side and openings to access the inverters and a cut-off switch on the other side. A rear door provides access to install the rack system until the rear door and frame are installed after the rack system is bolted to the floor. Each of the access opening comprises a door to seal the access openings. The doors or the door access openings comprise a fire resistant seal.
The base of the trailer or other support structure is connected onto the frame of the trailer and the main enclosure is connected to the base. The trailer may be a dual axle trailer.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A battery electrical storage system, comprising
an enclosure defining an inner volume, doors that seal the enclosure and allow access to the internal components;
a fire detection and monitoring system comprising sensors to monitor the inner volume for concentrations of combustible gases, wherein the fire detection system comprises a passive mitigation system that responses to a build-up of pressure in the inner volume or an increase in the concentrations of combustible gases and an active mitigation system comprising at least one of an exhaust blower and intake fan that is operated by the fire detection and monitoring system;
a battery rack, the battery rack comprising a first shelf for receiving a first battery module, a second shelf for receiving a second battery module, and a third shelf for receiving a third battery module; and
a first battery module on the first shelf, a second battery module on the second shelf, a third battery module of the third shelf and the first battery module and the second battery module define a first flow channel for air flow and cooling and the second battery module and the third battery module define a second flow channel for air flow and cooling.

2. The battery electrical storage system of claim 1, wherein the enclosure comprises a first side wall and a front wall; and the first battery module and the front wall define a third flow channel for air flow and cooling.

3. The battery electrical storage system of claim 2, wherein second container and the first side wall further define the third flow channel for air flow and cooling.

4. The battery electrical storage system of claim 3, wherein the enclosure comprises a back wall and the first battery module and the back wall defines a fourth flow channel for the air flow and cooling.

5. The battery electrical storage system of claim 4, wherein the enclosure comprises a second side wall and the first battery module and the second side wall define a fifth flow channel for the air flow and cooling.

6. The battery electrical storage system of claim 1, wherein the first shelf and the second shelf are a fire resistant second shelf.

7. The battery electrical storage system of claim 2, wherein the first side wall comprises an access door providing access to the first battery module.

8. The battery electrical storage system of claim 5, wherein the access door comprises a water-resistant seal.

9. The battery electrical storage system of claim 1, wherein the enclosure comprises a roof surface and at least one side wall and at least one of the roof surface and the side wall comprises at least one over pressure vent.

10. The battery electrical storage system of claim 1, wherein the battery rack defines two or more battery modules.

11. The battery electrical storage system of claim 1, wherein the battery rack defines six or more battery modules.

12. The battery electrical storage system of claim 1, wherein each battery module comprises a plurality of battery cells within the battery module.

13. The battery electrical storage system of claim 8, wherein each battery shelf has a battery module on the battery shelf.

14. The battery electrical storage system of claim 1, wherein the battery modules have a combined capacity over 20 kWh.

15. The battery electrical storage system of claim 1, wherein the battery modules have a combined capacity of over 50 kWh.

16. The battery electrical storage system of claim 1, comprising at least one photovoltaic solar panel configured to charge the batteries.

17. The battery electrical storage system of claim 1, comprising three photovoltaic solar panels configured to charge the batteries.

18. The battery electrical storage system of claim 13, wherein the photovoltaic solar panels are mounted slidably on top of the trailer enclosure.

19. The battery electrical storage system of claim 14, wherein one solar panel is rigidly connected to the top of the trailer body.

20. The battery electrical storage system of claim 15, wherein the photovoltaic solar panels are externally mounted to the trailer.

21. The battery electrical storage system of claim 1, comprising at least one electrical inverter to convert DC electricity to A/C electricity.

22. The battery electrical storage system of claim 1, wherein each battery module is UL 1973 compliant.

23. The battery electrical storage system of claim 1, wherein the battery rack is UL 1973 compliant.

24. The battery electrical storage system of claim 1, wherein the battery electrical storage system comprises a battery management system.

25. The battery electrical storage system of claim 1, wherein the battery electrical storage system passes UL 9540A testing.

26. The battery electrical storage system of claim 1, wherein the battery rack comprises a plurality of rows of battery shelves.

27. The battery electrical storage system of claim 1, wherein the fire detection and monitoring system configured to activate the fire protection system.

28. The battery electrical storage system of claim 27, wherein the fire detection and monitoring system comprises infrared detections sensors and ultraviolet detection sensors located within an air flow channel between the first and second battery modules.

29. The battery electrical storage system of claim 2, comprising an explosion prevention system that comprises a sparkler system configured to ignite a localized concentration of gases within the enclosure and a passive explosion mitigation system configured to release explosive gas safely.

30. The battery electrical storage system of claim 1, wherein the battery electrical storage system receives UL 9540 listing.

31. The battery electrical storage system, comprising a top shelf for mounting at least one of an AC to DC inverters or a DC transformer.

32. The battery electrical storage system of claim 31, wherein the inverters are UL 1741 compliant.

33. The battery electrical storage system of claim 1, wherein the battery modules comprise both virgin and recycled battery cells.
